(19) United States
(12) Patent Application Publication
(10) Pub. No.: US 2009/0299975 A1
(43) Pub. Date: Dec. 3, 2009

(54) SYSTEM AND METHOD FOR DOCUMENT ANALYSIS, PROCESSING AND INFORMATION EXTRACTION

(76) Inventors: RONALD R. COIFMAN, North Haven, CT (US); Andreas C. Coppi, Groton, CT (US); Frank Geshwind, Madison, CT (US); Stephane S. Lafon, New Haven, CT (US); Ann B. Lee, Hamden, CT (US); Mauro M. Maggioni, New Haven, CT (US); Frederick J. Warner, New Haven, CT (US); Steven Zucker, Hamden, CT (US); William G. Fateley, Manhattan, KS (US)

Correspondence Address: FULBRIGHT & JAWORSKI, LLP, 666 FIFTH AVE, NEW YORK, NY, 10103-3198, US

(21) Appl. No.: 12/396,823

(22) Filed: Mar. 3, 2009

Related U.S. Application Data
(63) Continuation of application No. 11/165,633, filed on Jun. 23, 2005, now abandoned.
(60) Provisional application No. 60/582,242, filed on Jun. 23, 2004.

(51) Int. Cl. G06F 17/30; G06F 17/24

(52) U.S. Cl. 707/3; 715/255; 707/E17.022

(57) ABSTRACT

The present invention is directed to a method and computer system for representing a dataset comprising N documents by computing a diffusion geometry of the dataset comprising at least a plurality of diffusion coordinates. The present method and system stores a number of diffusion coordinates, wherein the number is linear in proportion to N.

### RELATED APPLICATION

This application claims priority benefit under Title 35 U.S.C. § 119(e) of provisional patent application No. 60/582,242, filed Jun. 23, 2004, which is incorporated by reference in its entirety.

### BACKGROUND OF THE INVENTION

The present invention relates to methods for organization of data, and extraction of information, subsets and other features of data, and to techniques for efficient computation with said organized data and features. More specifically, the present invention relates to mathematically motivated techniques for efficiently empirically discovering useful metric structures in high-dimensional data, and for the computationally efficient exploitation of such structures.

The term “data mining” as used herein broadly refers to the methods of data organization and subset and feature extraction. Furthermore, the kinds of data described or used in data mining are referred to as (sets of) “digital documents.” Note that this phrase is used for conceptual illustration only, can refer to any type of data, and is not meant to imply that the data in question are necessarily formally documents, nor that the data in question are necessarily digital data. The “digital documents” in the traditional sense of the phrase are certainly interesting examples of the kinds of data that are addressed herein.

### OBJECTS AND SUMMARY OF THE INVENTION

The present system and method described are herein applicable at least in the case in which, as is typical, the given data to be analyzed can be thought of as a collection of data objects, and for which there is some at least rudimentary notion of what it means for two data objects to be similar, close to each other, or nearby.

In an embodiment, the present invention relates to the fact that certain notions of similarity or nearness of data objects (including but not limited to conventional Euclidean metrics or similarity measures such as correlation, and many others described below) are not a priori very useful inference tools for sorting high dimensional data. In one aspect of the present invention, we provide techniques for remapping digital documents, so that the ordinary Euclidean metric becomes more useful for these purposes. Hence, data mining and information extraction from digital documents can be considerably enhanced by using the techniques described herein. The techniques relate to augmenting given similarity or nearness concepts or measures with empirically derived diffusion geometries, as further defined and described herein.

An aspect of the present invention relates to the fact that, without the present invention, it is not practical to compute or use diffusion distances on high dimensional data. This is because standard computations of the diffusion metric require d*n² or even d*n³ number of computations, where d is the dimension of the data, and n the number of data points. This would be expected because there are O(n²) pairs of points, so one might believe that it is necessary to perform at least n² operations to compute all pairwise distances. However, the present invention, as disclosed, includes a method for computing a dataset, often in linear time O(n) or O(nlog(n)), from which approximations to these distances, to within any desired precision, can be computed in fixed time.

The present invention provides a natural data driven self-induced multiscale organization of data in which different time/scale parameters correspond to different representations of the data structure at different levels of granularity, while preserving microscopic similarity relations.

Examples of digital documents in this broad sense, could be, but are not limited to, an almost unlimited variety of possibilities such as sets of object-oriented data objects on a computer, sets of web pages on the world wide web, sets of document files on a computer, sets of vectors in a vector space, sets of points in a metric space, sets of digital or analog signals or functions, sets of financial histories of various kinds (e.g. stock prices over time), sets of readouts from a scientific instrument, sets of images, sets of videos, sets of audio clips or streams, one or more graphs (i.e. collections of nodes and links), consumer data, relational databases, to name just a few.

In each of these cases, there are various useful concepts of said similarity, closeness, and nearness. These include, but are not limited to, examples given in the present disclosure, and many others known to those skilled in the art, including but not limited to cases in which the content of the data objects is similar in some way (e.g. for vectors, being close with respect to the norm distance) and/or if data objects are stored in a proximal way in a computer memory, or disk, etc, and/or if typical user-interaction with the objects is similar in some way (e.g. tends to occur at similar time, or with similar frequency), and/or if, during an interactive process, a user or operator of the present invention indicates that the objects in question are similar, or assigns a quantitative measure of similarity, etc. In the case of nodes in a graph, or in the case of two web pages on the Internet, the objects can be thought of as similar for reasons including, but not limited to, cases in which there is a link from one to the other.

Note that, in practical terms, although mathematical objects, such as vectors or functions, are discussed herein, the present invention relates to real-world representations of these mathematical objects. For example, a vector could be represented, but is not limited to being represented, as an ordered n-tuple of floating point numbers, stored in a computer. A function could be represented, but is not limited to be represented, as a sequence of samples of the function, or coefficients of the function in some given basis, or as symbolic expressions given by algebraic, trigonometric, transcendental and other standard or well defined function expressions.

In the present invention it is convenient to think of a digital document as an ordered list of numbers (coordinates) representing parametric attributes of the document. Note that this representation is used as an illustrative and not a limiting concept, and one skilled in the art will readily understand how the examples described above, and many others, can be brought in to such a form, or treated in other forms of representation, by techniques that are substantially equivalent to those describe herein.

Such digital documents, e.g. images and text documents having many attributes, typically have dimensions exceeding 100. In accordance with an embodiment of the present invention, the use of given metrics (i.e., notions of similarity, etc.) in digital document analysis is restricted only to the case of very strong similarity between documents, a similarity for which inference is self evident and robust. Such similarity relations are then extended to documents that are not directly and obviously related by analyzing all possible chains of links or similarities connecting them. This is achieved through the use of diffusions processes (processes that are analogous to heat-flow in a mathematical sense that will be described herein), and this leads to a very simple and robust quantity that can be measured as an ordinary Euclidean distance in a low dimensional embedding of the data. The term embedding as used herein refers to a “diffusion map” and the distance thereby defined as a “diffusion metric.”

Various other objects, advantages and features of the present invention will become readily apparent from the ensuing detailed description, and the novel features will be particularly pointed out in the appended claims.

### BRIEF DESCRIPTION OF THE DRAWINGS

For a more complete understanding of the present invention, reference is now made to the following descriptions taken in conjunction with the accompanying drawing, in which:

FIG. 1 shows a flowchart of an embodiment of a multiscale diffusion construction described in detail herein.

FIG. 2 shows a schematic representation of an imagined forest, with trees and shrubs, presumed to burn at different rates. The discussion associated with the figure illustrates an embodiment of the present invention in the context of analysis of the spread of fire in the forest, and illustrates a use of the embodiment in the analysis of diffusion in a network.

### DETAILED DESCRIPTION OF THE EMBODIMENTS

In accordance with an embodiment, the present invention relates to multiscale mathematics and harmonic analysis. There is a vast literature on such mathematics, and the reader is referred to the attached paper by Coifman and Maggioni, in the provisional patent application No. 60/582,242 and the references cited therein. The phrase “structural multiscale geometric harmonic analysis” as used herein refers to multiscale harmonic analysis on sets of digital documents in which empirical methods are used to create or enhance knowledge and information about metric and geometric structures on the given sets of digital documents. The present invention also relates to the mathematics of linear algebra, and Markov processes, as known to one skilled in the art.

The techniques disclosed herein provide a framework for structural multiscale geometric harmonic analysis on digital documents (viewed, for illustration and not limiting purposes, as points in R″ or as nodes of a graph). Diffusion maps are used to generate multiscale geometries in order to organize and represent complex structures. Appropriately selected eigenfunctions of Markov matrices (describing local transitions inferences, or affinities in the system) lead to macroscopic organization of the data at different scales. In particular, the top of such eigenfunctions are the coordinates of the diffusion map embedding.

The mathematical details necessary for the implementation of the diffusion map and distance are detailed in the provisional application articles: “Geometric Diffusions as a Tool for Harmonic Analysis and Structure Definition of Data” by Coifman, et al., and “Multiresolution Analysis Associated To Diffusion Semigroups: Construction And Fast Algorithms”, by Coifman and Maggioni. These articles are part of the provisional patent application No. 60/582,242.

The construction of the diffusion map in these two papers are described in a quite general manner. A diffusion map is constructed given any measure space of points X and any appropriate kernel k(x,y) describing a relationship between points x and y lying in X. Starting with such a basic point of view, the article provides anyone skilled in the art the means and methods to calculate the diffusion map, diffusion distance, etc.

These means and methods include, but are not limited to the following: 1) construction and computation of diffusion coordinates on a data set, and 2) construction and computation of multiscale diffusion geometry (including scaling functions and wavelets) on a data set.

The construction and computation of diffusion coordinates on a data set is achieved as described herein. The cited papers provide additional details. Below are descriptions of algorithms as used in some embodiments of the present invention. The terms “diffusion geometry” and “diffusion coordinates” as used herein are meant to include, but not be limited to, this notion of diffusion coordinates.

Algorithm for Computing Diffusion Coordinates

This algorithm acts on a set X of data, with n points—the values of X are the initial coordinates on the digital documents. The output of the algorithm is used to compute diffusion geometry coordinates on X.

Inputs:

An n × n matrix T: the value T(x,y) measures the similarity between
data elements x and y in X
An optional threshold parameter ε with a default of ε = 0: used to
“denoise” T by, e.g., setting to 0 those values of T that are less than
ε.
An optional output dimension k, with a default of k = n: the desired
dimension of the output dataspace.

Outputs:

An n × k matrix A: the value A(n₀, -) gives the coordinates of the
n₀^{th} point, embedded into k-dimensional space, at time t = 1.
A sequence of eigenvalues λ₁, ..., λₖ

Algorithm:

Set T₁( x, y ) = T( x, y ) if |T( x, y )| > ε, T₁( x, y ) = 0 otherwise
Set λ₁, ..., λₖ equal to the largest k eigenvalues of T₁
Set A to the matrix, the columns of which are the eigenvectors of
T₁ corresponding to the largest k eigenvalues of T₁.

Then, using the above, the diffusion coordinates at time t, diffCoordₜ(x) is computed via:

DiffCoordₜ(x)={λᵢ^{t}A(x,i)}_{i=1, . . . , k}

and the diffusion distance at time t, dₜ(x, y) is computed via the Euclidean distance on the diffusion coordinates:

$${{d}_{t} ( x , y )}^{2} = {\sum }_{i = 1}^{k} {{λ}_{i}^{2 t} ( A ( x , i ) - A ( y , i ) )}^{2}$$

Note that the thresholding step can be more sophisticated. For example, one could perform a smooth operation that sets to 0 those values less than ε₁ and preserves those values greater than ε₂, for some pair of input parameters ε₁<ε₂. Multi-parameter smoothing and thresholding are also of use. Also note that the matrix T can come from a variety of sources. One is for T to be derived from a kernel K(x,y) as described in the cited papers. K(x,y) (and T) can be derived from a metric d(x,y), also as described in the papers. In particular, T can denote the connectivity matrix of a finite graph. These are but a few examples, and one of skill in the art will see that there are many others. We list several embodiments herein and describe the choice of K or T. For convenience we will always refer to this as K.

The construction and computation of multiscale diffusion geometry (including scaling functions and wavelets) on a data set is achieved as described herein. The cited papers provide additional details. Below are descriptions of algorithms as used in some embodiments of the present invention. The terms “diffusion geometry” and “diffusion coordinates” as used herein are meant to include, but not be limited to, this notion of multiscale diffusion geometry and diffusion wavelets.

Algorithm for Computing Multiscale Diffusion Geometry

This algorithm acts on a set X of data, with n points—the values of X are the initial coordinates on the digital documents. The output of the algorithm is used to compute multiscale diffusion geometry coordinates on X, and to expand functions and operators on X, etc., as described in the cited papers.

Inputs:

An n × n matrix T: The value T(x,y) measures the similarity
between data elements x and y in X
A desired numerical precision ε₁
An optional threshold parameter ε with a default of ε = 0: Used to
“denoise” T by, e.g., setting to 0 those values of T that are less than
ε.
Optional stopping time parameters K, Iₘₐₓ, with a default of K = 1,
and Iₘₐₓ = infinity: Parameters that tell the algorithm when to stop.

Outputs:

A sequence of point sets Xᵢ, a sequence of sets of vectors Pᵢ with
each element of Pᵢ indexed by elements of Xᵢ, and a sequence of
matrices Tᵢ which is an approximation of the restriction of T^{2′} to Xⱼ

Algorithm:

Set T₀( x, y ) = T( x, y ) if |T( x, y )| > ε, T₁( x, y ) = 0 otherwise
Set X₀ = X; P₀ = {δₓ}_{x∈X}
Set i = 1 and loop:

Set \tilde{P}ᵢ = {Tᵢ₋₁x}_{x∈Pi-1}
Set Pᵢ = LocalGS_{ε1} (\tilde{P}ᵢ)
Set Xᵢ = <the index set of Pᵢ>
Set Tᵢ = Tᵢ₋₁* Tᵢ₋₁ restricted to Pᵢ, and written as a matrix on
Pᵢ.
Set i = i + 1
Repeat loop until either Pᵢ has K or fewer elements,
Or 1 = Iₘₐₓ

End

Above, LocalGS_{ε}( ) is the local Gram-Schmidt algorithm described in the provisional patent application (an embodiment of which is describe below), but in various embodiments it can be replaced by other algorithms as described in the paper. In particular, modified Gram Schmidt can be used. See the cited papers for details. Note as before that the thresholding step can be more sophisticated, and the matrix T can come from a variety of sources. See the preceding algorithm's notes.

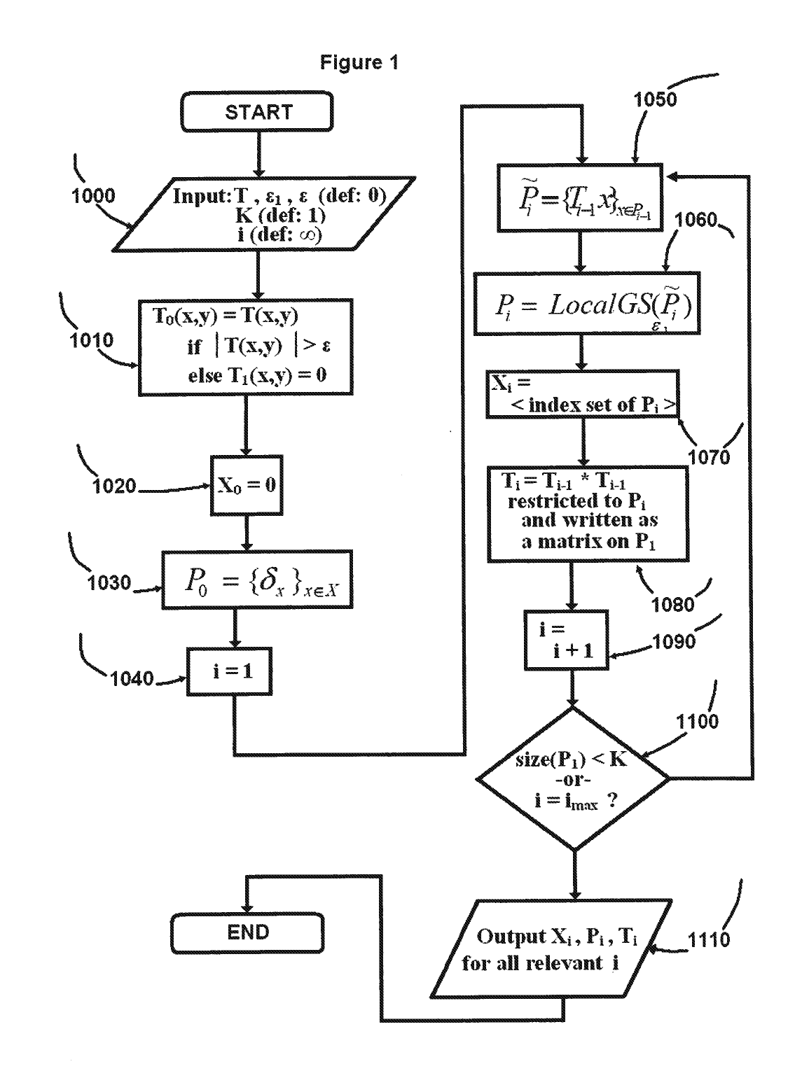

FIG. 1 shows the above algorithm as a flowchart. In flowchart element 1000, inputs are read into the algorithm. In flowchart elements 1010, 1020, 1030, and 1040, variables are initialized. Flowchart element 1050 begins a loop and sets \tilde{P}ᵢ={Tᵢ₋₁x}_{xεP}_{_{i−1}}. Flowchart element 1060 computes the local Gram Schmidt orthonormalization. Flowchart element 1070 sets Xᵢ to be the index set of Pᵢ. Flowchart element 1080 computes the next power of the matrix T, restricted to and written as a matrix on the appropriate set. Element 1090 of the flowchart increments the loop index i. Element 1100 of the flowchart is the loop-control test: if the stopping conditions are met, we get out of the loop, otherwise we loop back to flowchart element 1050. Flowchart element 1110 outputs the results of the algorithm.

The following gives pseudo-code for a construction of the diffusion wavelet tree, using the notation of the cited provisional application.

{Φⱼ}ⱼ₌₀^{J}, {Φⱼ}ⱼ₌₀^{J-1}, {[T²_{^{j}}]_{Φj}^{Φ}ⱼ}ⱼ₌₁^{J}−DiffusionWaveletTree
([T]_{Φ0}^{Φ}_{0,}Φ_{0,}J,SpQR,t) // Input:
// [T]_{Φ0}^{Φ}₀ : a diffusion operator, written on the o.n. basis Φ₀
// Φ₀ : an orthonormal basis which ∈-spans V₀
// J : number of levels to compute
// SpQR : a function compute a sparse QR decomposition, template below.
// t: precision
// Output:
// The orthonormal bases of scaling functions, Φⱼ, wavelets, Φⱼ, and
// compressed representation of T²_{^{j}}on Φⱼ, for j in the requested range.
for j = 0 to J − 1 do

1. [Φⱼ₊₁]_{Φj,} [T]_{Φ0}^{Φ}₁ −SpQR([T²^{ⱼ}]_{Φj}^{Φ}ⱼ,t)
2. Tⱼ₊₁ := [T²^{ⱼ₊₁}]_{Φj+1}^{Φ}ⱼ₊₁ −[Φⱼ₊₁]Φⱼ[T²^{ⱼ}]_{Φj}^{Φ}ⱼ[Φⱼ₊₁]_{Φj}*
3. [Φⱼ]_{Φj} −SpQR(I_{<Φj>}−[Φⱼ₊₁]_{Φj}[Φⱼ₊₁]_{Φj}*,t)

end

Function template:

Q,R −SpQR (A,∈) // Input:
// A: sparse n × n matrix
// t: precision
// Output:
// Q,R matrices, possibly sparse, such that A = ₜQR,
// Q is n × m and orthogonal,
// R is m × n, and upper triangular up to a permutation,
// the columns of Q ∈-span the space spanned by the columns of A.

An example of the SpQR algorithm is given by the following:

MultiscaleDyadicOrthogonalization (Φ,Q,J,s): //Φ: a family of functions
to be orthonormalized, as in Proposition 21
// Q : a family of dyadic cube on X
// J : finest dyadic scale
// t: precision
Φ₀ −Gram-Schmidt_{ε}^{(∪k∈K}^{_{J}}^{^{Φ}}^{|Q}^{_{j,k}}⁾l−1 do

1. for all k∈K_{J+1},

a. Φ_{l,k} −Φ|_{Qj+1 k} \ [symbol] _{Qj+l-1.k}⊂_{Qj+1,k}Φ|_{Qj+1-l,k}
b. Φ_{l,k} −Gram-Schmidt_{ε}(Φ_{l,k})
c. Φ_{l,k} − Gram-Schmidt_{ε}(Φ_{l,k})

2. end
3. l −l + 1

until Φₗ is empty.

A person skilled in the art will immediately understand several variations and generalizations of the algorithm above, including those that are suggested and presented in the cited papers.

In some embodiments of the present invention, the following version of the local Gram Schmidt procedure is used:

Algorithm for computing LocalGS_{ε}( P )
This algorithm acts on a set \tilde{P} of vectors (functions on X).
Inputs:

A set of vectors \tilde{P} , defined on X
A desired numerical precision ε₁

Outputs:

A set of vectors P

Algorithm:

Set j = 0
Set P = the empty list
Set Ψ₀ = \tilde{P}
LOOP0:

Pick dⱼ such that the vectors in ^{Ψ}ⱼ are each supported in a
ball of size dⱼ or less
Pick a point in X, at random. Call it x(j,0).
Let i = 1
Loop1:

Pick x(j,i) to be a closest point in X which is at
distance at least 2dⱼ from each of the points x(j,0),
..., x(j,i−1)
If there is no such point x(j,i), set Kⱼ = (i−1), and
break out of the loop1, otherwise, set i = i_+ 1, and
goto loop1:

Set Ψⱼ = the set of vectors in Ψⱼ orthogonalized to P, by
ordinary Gram Schmidt (if P is empty, simply set Ψⱼ =^{Ψ}ⱼ)
Set \tilde{Pⱼ₊₁} to be the set of vectors, v, in Ψⱼ for which there is
some k, with 0 <= k <= Kⱼ, such that v is supported in a ball
of radius 2dⱼ centered at x(j,k)
Use modifiedGramSchmidt_{ε1} to orthogonalize \tilde{Pⱼ₊₁} to P;
call the result [symbol] ⱼ₊₁
(Comment: This orthonormalization is local: each function,
being supported on a ball of size dⱼ around some point x,
interacts only with the functions in P in a ball of radius 2dⱼ
containing x. Moreover, the points in [symbol] ⱼ₊₁ therefore have
the property that each is supported in a ball of radius 3dⱼ)
Set Φⱼ₊₁ = modifiedGramSchmidt_{ε1} ( [symbol] ⱼ₊₁).
(Comment: Observe that this orthonormalization procedure
is local, in the sense that each function in [symbol] ⱼ₊₁ only interacts
with the other functions in [symbol] ⱼ₊₁ that are supported in the
same ball of radius Cdⱼ.)
Set Ψⱼ₊₂ = Ψⱼ₊₁ − \tilde{P}ⱼ₊₁
Set P ← P∪Φⱼ₊₁
If Ψⱼ₊₂, is not empty, set j = j+1 and goto LOOP0

End

As seen from the pseudo-code herein, the construction of the wavelets at each scale includes an orthogonalization step to find an orthonormal basis of functions for the orthogonal complement of the scaling function space at the scale into the scaling function space at the previous scale.

The construction of the scaling functions and wavelets allows the analysis of functions on the original graph or manifold in a multiscale fashion, generalizing the classical Euclidean, low-dimensional wavelet transform and related algorithms. In particular the wavelet transform generalizes to a diffusion wavelet transform, allowing one to encode efficiently functions on the graph in terms of their diffusion wavelet and scaling function coefficients. In some embodiments of the present invention, the wavelet algorithms known to those skilled in the art are practiced with diffusion wavelets as disclosed herein.

For example, functions on the graph or manifold can be compressed and denoised, for example by generalizing in the obvious way the standard algorithms (e.g. hard or soft wavelet thresholding) for these task based on classical wavelets.

For example if the nodes of the graph represent a body of documents or web pages, user's preferences (for example single-user or multi-user) are a function on the graph, that can be efficiently saved by compressing them, or can be denoised.

As another example, if each node has a number of coordinates, each coordinate is a function on the graph that can be compressed and denoised, and a denoised graph, where each node has as coordinates the denoised or compressed coordinates, is obtained. This allows a nonlinear structural multiscale denoising of the whole data set. For example, when applied to a noisy mesh or cloud of points, this results in a denoised mesh or cloud of points.

Similarly, diffusion wavelets and scaling functions can be used for regression and learning tasks, for functions on the graph, this task being essentially equivalent to the tasks of compressing and denoising discussed above.

As an example, standard regression algorithms known for classical wavelets can be generalized in an obvious way to algorithms working with diffusion wavelets

In an embodiment of the present invention, a space or graph can be organized in a multiscale fashion as follows. The terms “diffusion geometry” and “diffusion coordinates” as used herein are meant to include, but not be limited to, this notion of multiscale geometry.

Alternate Multiscale Geometry Algorithm

Inputs:

a set X with a kernel K or some other measure of similarity as
described herein;
a number r (a radius)
a stopping parameter L

Output:

A sequence X₁, ..., X_{M} of set of points, yielding a multiscale
clustering of the set X

Algorithm:

Compute diffusion geometry of the set X
Set X₀ = X
Set i = 1
Loop:

Set Xᵢ to be a maximal set of points in Xᵢ₋₁ with mutual
distance >= r in the diffusion geometry with parameter t =
2ⁱ
If Xᵢ has more than L points, set i = i + 1 and goto Loop:

End.

The present invention has embodiments relating to searching web pages on internets and intranets. Similarly, there are embodiments relating to indexing such webs. In the most rudimentary embodiment, the points of the space X will represent documents on the Web, and the kernel k will be some measure of distance between documents or relevance of one document to another. Such a kernel may make use of many attributes, including but not limited to those known to practitioners in the art of web searching and indexing, such as text within documents, link structures, known statistics, and affinity information to name a few.

One aspect of the present invention can be understood by considering it in contrast with Google's PageRank, as described, for example, in U.S. Pat. No. 6,285,999. In some sense PageRank reduces the web to one dimension. It is very good for what it does, but it throws away a lot of information. With the present invention, one can work at least as efficiently as PageRank, but keep the critical higher-dimensional properties of the web. These dimensions embody the multiple contexts and interdependencies that are lost when the web is distilled to a ranking system. This view opens the door to a huge number of novel web information extraction techniques.

The present invention is applicable for affinity-based searching, indexing and interactive searches. The ideas include algorithms that go beyond traditional interactive search, allowing more interactivity to capture the intent of the user. We can automatically identify so-called social clusters of web pages. The core algorithm is adapted to searching or indexing based on intrinsic and extrinsic information including items such as content keywords, frequencies, link popularity and other link geometry/topology factors, etc., as well as external forces such as the special interests of consumers and providers. There are implications for alternatives to banner ads designed to achieve the same results (getting qualified customers to visit a merchant's site).

The present invention is ideal for attacking the problem of re-parametrizing the Internet for special interest groups, with the ability to modulate the filtering of the raw structure of the WWW to take in to account the interests of paid advertisers or a group of users with common definable preferences. By this, we refer to the concept of building a web index of the kind popular in contemporary web portals. Beyond users and paid advertisers, so filtering is clearly useful to many others, e.g. market analysts, academic researchers, those studying network traffic within a personalized subnet of a larger network, etc.

In an embodiment of the present invention, a computer system periodically maps the multiscale geometric harmonic diffusion metric structure of the internet, and stores this information as well as possibly other information such as cached version of pages, hash functions and key word indexes in a database (hereafter the database), analogous to the way in which contemporary search engines pre-compute page ranking and other indexing and hashing information. As described above, the initial notion of proximity used to elucidate the geometric harmonic structure can be any mathematical combination of factors, including but not limited to content keywords, frequencies, link popularity and other link geometry/topology factors, etc., as well as external forces such as the special interests of consumers and providers. Next, an interface is presented to users for searching the web. Web pages are found by searching the database for the key words, phrases, and other constraints given by the users query. One aspect of the present invention is that, as seen from this disclosure by one skilled in the art, the search can be accelerated by using partial results to rapidly find other hits. This can be accomplished, for example, by an algorithm that searches in a space filling path spiraling out from early search hits to find others, or, similarly, that uses diffusion techniques as discussed below to expand on early search hits.

Once the search results are gathered, the results can be presented in ways that relate to the geometry of the returned set of web pages. Popularity of any particular site can be used, as is done in common practice, but this can now be augmented by any other function of the geometric harmonic data. In particular, results can be presented in a variety of evident non-linear ways by representing the higher-dimensional graph of results in graphical ways standard in the art of graphic representation of metric spaces and graphs. The latter can be enhanced and augmented by the multiscale nature of the data by applying said graphical methods at multiple scales corresponding to the multiscale structures described herein, with the user controlling the choice of scale.

In an embodiment of the present invention, web search results, web indexes, and many other kinds of data, can be presented in a graphical interface wherein collections of digital documents are rendered in graphical ways standard in the art of graphic representation of said documents, and combined with or using graphical ways standard in the art of graphic representation of metric spaces and graphs, and at the same time the user is presented with an interface for navigation of this graph of representations. As an illustration, this would be analogous to database fly-through animation as is common in the art of flight simulators and other interactive rendering systems.

In a further aspect, a web browser can be provided in accordance with the present invention, with which the user can view web pages and traverse links in said pages, in the usual way that contemporary browsers allow. However, using the present invention, and in particular the navigation aspect described in the previous paragraph, users can be presented with the option of jumping to another web page that is close to the current web page in diffusion distance, whether or not there is an explicit link between the pages. Of course, again, the navigation can be accomplished in a graphical way. Again, web pages near the current web page can be clustered using standard art clustering techniques applied to the database and the diffusion distance. At any given scale in the multiscale view, each cluster or navigation direction can be labeled with the most popular word, words, phrases or other features common among document in that cluster or direction. Of course, in doing this, as is standard in the art, certain common words such as (often) pronouns, definite and indefinite articles, could be excluded from this labeling/voting.

In another aspect, the present invention can be used to automatically produce a synopsis of a web page (hereinafter a contextual synopsis). This can be done, for example, as follows. At multiple scales, cluster a scale-appropriate neighborhood of the web page in question. Compute the most popular text phrases among pages within the neighborhood, weighting according to diffusion distance from current location. Of course, throw out generically common words unless they are especially relevant, for example words like ‘his’ and ‘hers’ are generally less relevant, but in the colloquial phrase “his & hers fashions” these become more relevant. The top N results (where N is fixed a priori, or naturally from the numerical rank of the data), give a natural description of the web page.

The contextual synopsis concept described in the previous paragraph allows one to compare a web page textually to its own contextual synopsis. A page can be scored by computing its distance to its own contextual synopsis. The resulting numerical score can be thought of as a measure analogous to the curvature of the Internet at the particular web page (hereafter contextual curvature). This information could be collected and sold as a valuable marketing analysis of the Internet. Submanifolds given by locally extremal values of contextual curvature determine “contextual edges” on the Internet, in the sense that this is analogous to a numerical Laplacian (difference between a function at a point, and the average in a neighborhood of the point).

In a related aspect of the present invention, it is seen that various information on diffusion-geometric properties of the sites and sets of sites on the Internet can be collected as valuable marketing and analysis material. The technique described above yields automatic clustering of the Internet at multiple scales, and can therefore be used, as already disclosed, to build web indexes of the kind popular in contemporary web portals. Moreover, one can use this technique as already described to systematically discover holes in the internet; that is, non-uniformities or more complex algebraic-topological features of the Internet, that naturally represent valuable marketing and analysis material, for example to automatically critique a web site, or to identify the need/opportunity to create or modify a web site or set of sites, or to improve the flow of traffic through a web site or collection of sites.

In this connection, there are embodiments of the present invention that allow for the analysis of the effect of proposed modification or additions to the world wide web, prior to such modification or additions being made. In its simplest form, this amounts to computing the database of diffusion metric data as already described, and then computing the changes in diffusion metric information that would result, were a certain set of changes to be made. Using this, one can do things including, but not limited to, computing the solution to an optimization problem stated in terms of diffusion distances. In this way, the present invention yields methods for optimizing web-site deployment.

Combining the previous idea with the observation that current web banner adds are designed to move users from viewing a given web page X, to viewing a web page Y, with probability p, depending on the users profile, the present invention yields methods for replacing web advertisement with a more passive and unobtrusive means for obtaining the same result. Indeed, the diffusion metric database, augmented with contextual information as already disclosed herein, is precisely the information set that relates to the probability that a user with a given profile will go from viewing any particular web page, X, to another web page, Y. By setting up and solving the optimization problem defined by setting this probability to any desired p, one can discover the interconnectedness of a set of new web pages or links, together with contextual informative descriptions of said pages, the introduction of which will create the desired effect that is the goal of a contemporary web advertisement.

It is worth noting that the above information is additionally useful in connection with statistical information about web surfing patterns (as used herein, “web surfing”, here, means simply the action of a user of web information, successively viewing a series of web pages by following links or by other standard means). In this connection, the present invention has embodiments that incorporate information collected by web servers that gather statistics on links followed and pages visited, perhaps augmented by so-called cookies, or other means, so as to track which users have viewed which web pages, and in what order, and at what time. In its simplest form, this information is exploited by simply weighting the metric links according to their probability of being followed to constructing the initial notion of similarity from which the diffusion data are derived.

In accordance with an embodiment, the present invention can be used to discover models of Internet users surfing patterns obviating the need for server acquired statistics. Indeed, the contextual synopsis information, applied to web pages and clusters of pages, present a model of user profiles. Combining this with the diffusion metric structure of the present invention, and other statistical information such as demographic studies, by any means standard in the art or otherwise, yields novel models of user profiles and corresponding surfing statistics.

The present invention yields a new mode of interactive web searches: hyper-interactive web searches. One embodiment of a method for such searches consists of presenting the user with a first geometric harmonic based web search as described herein, and then allowing the user to characterize the results from said first search as being near or far from what the user seeks. The underlying distance data is then updated by adding this information as one or more additional coordinates in the n-tuples describing each web page, and using diffusion to propagate these values away from the explicit examples given by the user.

Alternatively or in addition, contextual synopsis data of the indicated web pages can be used to augment the search criteria. In this way, by using the new metric and/or the new search criteria, another modified search can be conducted. The process can be iterated until the user is satisfied. In each of these cases, the process can include the refinement of searches by, for example, filtering the results, augmenting or refining the search query, or both.

The searching technique discussed herein can be applied to databases rather than web site information, as will be readily seen by one skilled in the art, and as described hereinbelow.

In accordance with an embodiment of the present invention, a database of any sort can be analyzed in ways that are similar to the analysis of the Internet and World Wide Web described herein. In particular, a static database or file system may play the role of X, with each point of X corresponding to a file. The kernel in this case might be any measure useful for an organizational task—for example, similarity measures based on file size, date of creation, type, field values, data contents, keywords, similarity of values, or any mixture of known attributes may be used.

In particular, the set of files on a user's computer, hard drive, or on a network, may be automatically organized into contextual clusters at multiple scales, by the means and methods disclosed herein. This process can be augmented by user interaction, in which the process described above for contextual information is carried out, and the user is provided with the analysis. The user can then select which automatically derived contexts are of interest, which need to be further divided, which need to be combined, and which need to be eliminated. Based on this, the process can be iterated across scales until the user is satisfied with the result.

In accordance with an embodiment of the present invention, the method and system disclosed herein can be used in collaborative filtering. In this application, the customers of some business or organization might play the role of X, and the kernel would be some measure of similarity of purchasing patterns. Interesting patterns among the customers and predictions of future behavior may be be derived via the diffusion map. This observation can also be applied to similar databases such as survey results, databases of user ratings, etc.

In particular, to illustrate the collaborative filtering example, an embodiment of the present invention can proceed as follows:

In this description we will consider a business that has n customers and sells m products. The embodiment works by first forming the n×m matrix: M(x,y)=the number of times that customer #x has purchased product #y. Using a fast approximate nearest neighbors algorithm, compute a sparse n×n matrix T such that T(x1,x2) is the correlation between normalized vectors of purchases between customers x1 and x2 (i.e. correlate normalized versions of the rows x1 and x2 of the matrix M when the correlation is expected to be high, take 0 otherwise. Here, normalized can mean, for example, converting counts to fractions of the total: i.e. dividing each row by its sum prior to the inner product). Note that correlation is used simply as an example. One could also use, for example, a matrix with the value 1 for any pair of customers that have some fixed number of purchases in common, and 0 otherwise.

Note that one can also compute the m×m matrix S from correlations, counts, or generally similarities between products that have similar sets of customers buying them.

For each of the matrices T and S, compute the diffusion geometry and/or the multiscale diffusion geometries as described above, acting on the matrices T and S.

From this, one gets a low dimensional representation of the set of customers, and the set of products, such that the customers are close in the map when the preponderance of similarities between their purchase habits is close, as viewed from the context of inference from similarity of behavior of the population. Similarly, one gets a low dimensional map of the products, in which products are close in the map when the preponderance of similarities between their purchase histories is close, as viewed from the context of inference from similarity of behavior of the population.

Of course, at each stage of the iteration in the multiscale construction, one can use the clustering on Xᵢ, say for the customers, to put new coordinates on the set of products (i.e., one forms a new matrix M from Xᵢ of the customers to Xᵢ of the products, constructs new T and S). When one does this, one works from the new matrices T and S, and the result is a multiscale organization of the customers and a multiscale organization of the products. In a related embodiment, the multiscale structure induced, say on the rows of the matrix M at a given scale in the construction, can be used to create new coordinates on the columns of the matrix. The columns can be organized in these new coordinates. Then these in turn give new coordinates on the rows, and the iteration follows. Each of these multiscale organizations will be mutually compatible because the matrix M is rewritten at each step in the algorithm to make it so.

The preceding discussion applies in cases beyond that of customers and the products that they purchase. For example, the matrix M(x,y) above could be just a well a matrix that counts the frequency of occurrence of word x in web page y. In this way, one gets a multiscale organization of words on the one hand, and a multiscale organization of the set of web documents on the other hand, and these are mutually compatible. AS another example, consider a set of music files, and a set of playlists consisting of lists from this set of files. A matrix M(x,y) can be formed with M(x,y)=1 when song x is on playlist y, and 0 otherwise. Again, the matrices T and S can be formed, and compatible multiscale organizations of artists and playlists generated. The resulting multiscale structure on sets of songs will constitute a kind of automatically generated classification into genres and sub-genres. Similarly, on the playlists, one gets a kind of multiscale classification of playlists by “mood” and “sub-mood”. Yet another example of a similar embodiment consists of one in which the files on a computer are automatically organized into a hierarchy of “folders” by taking a matrix M(x,y) where x indexes, say, keywords, and y indexes documents. The multiscale structure is then a auomatically generated filesystem/folder structure on the set of files. Of course, x could be some data other than keywords, as described elsewhere in this disclosure. These examples, as all other, are meant to be illustrative and not limiting and one skilled in the art will readily see variations.

In some embodiments it is helpful to use subsets of the data first; building the multiscale structure on these subsets and then classifying the larger (original) set of data according to the result. For example, in the music vs playlist embodiment described, once could start with the most popular songs (or, say, the most popular artists). After running the procedure described, a multiscale characterization of genres and sub-genres is created. Since these are coordinates on the data, they can be evaluated by linear extension on the omitted (less popular) songs or artists. In this way, the orphaned songs are classified into the hierarchy of genres and sub-genres automatically. Moreover, as new music and new playlists are added to the system, these new items are automatically classified according to genre and sub-genre in the same way.

In some embodiments of the present invention it is helpful to throw away uninformative data points at each scale of the algorithm. For example, as describe above, it is helpful to temporarily work on subset of the data according to popularity (i.e. large values of the matrix M). In another example, when processing documents, typically so-called stop words are ignored. Stop words are simply words that are so common that they are usually ignored in standard/state of the art search systems for indexing and information retrieval.

In accordance with an embodiment of the present invention, the method and system disclosed herein can be used in network routing applications. Nodes on a general network can play the role of points in the space X and the kernel may be determined by traffic levels on the network. The diffusion map in this case can be used to guide routing of traffic on the network. In this example, it is seen that the matrix T can be taken to be any of the standard network similarity matrices. For example, node connectivity, weighted by traffic levels. The embodiment proceeds as above, and the result is a low-dimensional embedding of the network for which ordinary Euclidean distance corresponds to diffusion distance on the graph. Standard algorithms for traffic routing, network enhancement, etc, can then be applied to the diffusion mapped graph in addition to or instead of the original graph, so that results will similarly be mapped to results relevant for diffuse flow of events, resources, etc, within the graph.

In accordance with an embodiment of the present invention, the method and system disclosed herein can be used in imaging and hyperspectral imaging applications. In this case, each spatial (x-y) point in the scene will be a point of X and the kernel could be a distance measure computed from local spatial information (in the imaging case) or from the spectral vectors at each point. The diffusion map can be used to explore the existence of submanifolds within the data.

In accordance with an embodiment of the present invention, the method and system disclosed herein can be used in automatic learning of diagnostic or classification applications. In this case, the set X consists of a set of training data, and the kernel is any kernel that measures similarity of diagnosis or classification in the training data. The diffusion map then gives a means to classify later test data. This example is of particular interest in a hyper-interactive mode.

In accordance with an embodiment of the present invention, the method and system disclosed herein can be used in measured (sensor) data applications. The (continuous) data vectors which are the result of measurements by physical devices (e.g. medical instruments) or sensors may be thought of as points in a high dimensional space and that space can play the role of X in our disclosure. The diffusion map may be used to identify structure within the data, and such structure may be used to address statistical learning tasks such as regression.

As an illustrative example of an embodiment of the present invention, consider the problem of trying to model how a fire might spread over a geographic region (e.g. for forest fire control and planning). Imagine a geographic map (or graph) in which each site is connected to its immediate neighbors by a weighted link measuring the rate (risk) of propagation of fire between the sites. The remapping by the diffusion map reorganizes the geography so that the usual Euclidean distance between the remapped sites represents the risk of fire propagation between them. In this way, a system can be designed utilizing the present invention. The system in question would take as input the possibly dynamic information about local fire propagation risk. The system would then compute the multiscale diffusion metric. The system would then display a caricaturized map of the region, where distance in the display corresponds to risk of fire spreading. Superimposed on this display could be information about where fires are currently burning, allowing the user to have immediate situational awareness, being able to assess, in real time and using natural human skills, where the fire is likely to spread next. This situational awareness is computable in real time and can be updated on the fly as conditions change (wind, fuel, etc. . . . ). The points affected by a fire source can be immediately identified by their physical (Euclidean) proximity in the diffusion map. The system would also be useful for simulating the effects of contemplated countermeasures, thus allowing for a new and valuable means for allocation of fire fighting resources.

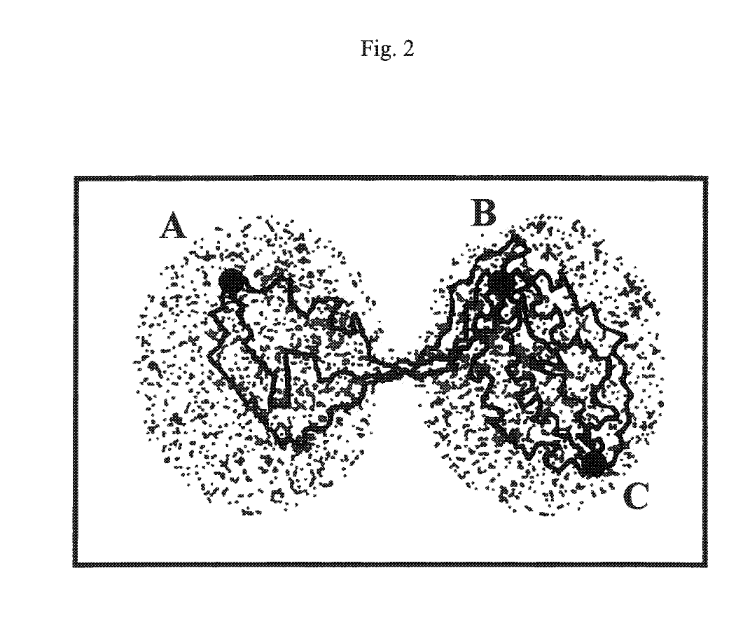

Turning now to FIG. 2, the risk of fire propagating from B to C is greater than from B to A, since there are few paths through the bottleneck. In the diffusion geometry the two clusters are substantially far apart.

The example just given illustrates a more general point; that the present invention is suited to solving problems including but not limited to those of resource allocation, to the allocation of finite resources of a protective nature, and to problems related to civil engineering. For example, to illustrate but not limit, consider the problem of where to place a given number of catastrophe countermeasures on the supply lines of a public utility. By using diffusion mathematics, one can setup and then solve the corresponding numerical optimization problem that maximizes the distance between clusters, or points within the low-pass-filtered version of the supply network (in the sense of the attached Coifman & Maggioni paper. As another example, given census data about places of abode and places of employment, as well other data on travel patterns of the citizens of a region, one can define a diffusion metric from initial data relating to the probability of a person traveling from one location to another. Roads, as well as public transportation routes and schedules, can then all be planned so that the capacity of transport between locations is equal to the diffusion distance. These examples are of course directly applicable to problems of network traffic routing and load balancing of any kind, such as telecommunications networks, or internet services, such as those disclosed in U.S. Pat. No. 6,665,706 and the references cited therein and by chain of continuation.

In a search application, we can think of sites as digital documents which are tightly related to their immediate neighbors, the links representing the strengths of inference (or relationship) between them. The multiplicity of paths connecting a given pair of documents represents the various chains of inference, each of which carries some particular weight with the sum ranking the relation between them.

In the context of characterizing customers of a business, we can view each customer as a “site”, with the corresponding list of customer attributes being the digital document. We only link customers whose attributes are very similar in order to map out the relational structure of the customer base. Good customers are then identified by their natural proximity to known customers, and a risk level can be identified by the preponderance of links (or distance in the map) from a given customer to “dead beats”.

The concepts of text, context, consumer patterns (usage patterns), and hyper-interactive searching, as articulated above, in the context of internet web searching and indexing, all have analogs in the context of the analysis of databases. For example, a book retailer can compute the multi-scale diffusion analysis of the database of all books for sale, using within the metric items, such as subject, keywords, user buying patterns, etc., keywords and other characteristics that are common over multiscale clusters around any particular book provide an automatic classification of the book—a context. A similar analysis can be made over the set of authors, and another similar analysis on the set of customers. In this way, new methods arise allowing the retailer to recommend unsolicited items to potential buyers (when the contexts of the book and/or author and/or subject, etc, match criteria from the derived context parameters of the customer). Of course this example is meant to be illustrative and not limiting, and this approach can be applied in a quite general context to automate or assist in the process of matching buyers with sellers.

The methods and algorithms described herein have application in the area of automatic organization or assembly of systems. For example, consider the task of having an automated system assemble a jigsaw puzzle. This can be accomplished by digitizing the pieces, using information about the images and the shapes of the pieces to form coordinates in any of many standard ways, using typical diffusion kernels, possibly adapted to reflection symmetries, etc., and computing diffusion distances. Then, pieces that are close in diffusion distance will be much more likely to fit together, so a search for pieces that fit can be greatly enhanced in this way. Of course, this technique is applicable to many practical automated assembly and organization tasks.

The methods and algorithms described herein have application in the area of automatic organization of data for problems related to maintenance and behavioral anomaly detection. As a simple illustration, suppose that the behavior of a set of active elements of some kind is characterized using a number of parameters. Running a diffusion metric organization on that set of parameters yields an efficient characterization of the manifold of “normal behavior”. This data can then be used to monitor active elements, watching how their behavior moves about on this normal behavior manifold, and automatically detecting anomalous behaviors. In addition, as describe in the myriad of examples herein, the characterization allows for the grouping of active elements into similarity classes at different scales of resolution, which finds many applications in the organization of said active elements, as they can be “paired up” or grouped according to behavior, when such is desirable, or allocated as resources when such is desirable. In fact, this ability to group together active elements in any context, with the grouping corresponding to similarity of behavior, together with the ability to automatically represent and use this information at a range of resolutions, as disclosed herein, can be used as the basis for automated learning and knowledge extraction in a myriad of contexts.

An embodiment of the present invention relates to finding good coordinate systems and projections for surfaces and higher dimensional manifolds and related objects. Indeed, a basic observation of the present work is that the eigenvectors of Laplacian operators on the surfaces (manifolds, objects) provide exactly such. The multi-scale structures, described in the attached paper of Coifman and Maggioni, give precise recipes for then having a series of approximate coordinates, at different scales and different levels of granularity or resolution, as well as a method for automatically constructing a series of multi-resolution caricatures of the surfaces, manifolds, etc. There are direct applications of these ideas for representations of objects in computer aided design (CAD) systems, as well as processes for sampling and digitization of 2D and 3D objects.

An embodiment of the present invention relates to the analysis of a linear operator given as a matrix. If the columns of the matrix are viewed as vectors in R^{N}, and any standard diffusion kernel used, then the matrix can be compressed in the diffusion embedding, allowing for rapid computation with the matrix.

An aspect of the present invention relates to the automated or assisted discovery of mappings between different sets of digital documents. This is useful, for example, when one has a specific set of digital documents for which there is some amount of analytical knowledge, and one or more sets of digital documents for which there is less knowledge, but for which knowledge is sought. As a simple concrete example, consider the problem of understanding a set of documents in an unknown language, given a corresponding set of documents in a known language, where the correspondence is not known a priori. In this problem, one wants to build a “Rosetta stone.”

In an embodiment, consider two sets of digital documents, A and B. Begin by organizing A and B using any appropriate diffusion metric. Now, build two new sets of digital documents A′ and B′. For each document D in A, let S be the set of nearest neighbors of D in the diffusion embedding within some fixed radius (this radius is a parameter in the method), translated to the origin by subtracting the coordinates of D in the diffusion embedding. Now replace S with the corresponding member from an a priori fixed coset under the action of the unitary group, thus capturing just the local geometry around S. Now place a point D′ in A′, with coordinates equal to this reduced S. Optionally, the coordinates of D′ could be taken to be the reduced S coordinates at a few different multi-scale resolutions. Next, compute B′ in the corresponding way. Now compute a diffusion mapping for C′=the union of A′ and B′. In doing so, one can optionally use a kernel that is adapted to measure distance via something analogous to “edit distance”, which counts the number of additions and deletions of points (nearest neighbors at different scales) from one set, needed to bring the set to within some parametrically fixed distance of the other set (recalling that this distance is a distance between two sets of points), and optionally also relates to the ordinary distance between the coordinates of the two points, or optionally to the coordinates after said edit operation. The end result will be that two documents D1′ in A′ and D2′ in B′ will be close when a good candidate for a mapping of A to B sends D1 to D2.

In one view, the original problem can be stated as that of finding a natural function mapping between A and B, but with the added complexity that either A or B or both might be incomplete, so that one really seeks a partial mapping. It is natural to require that this mapping, where defined, be a quasi-isometry, or at least a homeomorphism. In any case, theoretically since A and B are finite, a brute-force search would yield an optimal mapping, although it would be intractable to carry out such a search directly. The procedure in the previous paragraph pre-processes the data so as to greatly reduce the cost of such a search. In practical problem for which it is possible to make progress from partial information, such as the Rosetta stone example, the process can be iterated, adjusting the metric with said partial progress information.

In accordance with an embodiment of the present invention, the method and system relates to organizing and sorting, for example in the style of the “3D” demonstration. In that demonstration, the input to the algorithm was simply a randomized collection of views of the letters “3D”, and the output was a representation in the top two diffusion coordinates. These coordinates sorted the data into the relevant two parameters of pitch and yaw. Since, in general, the diffusion metric techniques disclosed herein have the power to piece together smooth objects from multi-scale patch information, it is the right tool for automated discovery of smooth morphisms (using “smooth” in a weak sense).

The mathematical particulars which distinguish our disclosure (those listed under the heading “Fundamental Aspects of Diffusion Maps/Distances”) make certain problems tractable which otherwise would be prohibitively expensive for extended graph structures (such as real-world networks) and large data volumes (such as those collected in hyperspectral imaging applications).

The methods are applicable also for non-symmetric diffusions. As described in “Multiresolution Analysis Associated To Diffusion Semigroups: Construction And Fast Algorithms”, by Coifman and Maggioni. The point being that many transitions or inferences as occurring in applications (in web searches for example) are not necessarily symmetric. In general this lack of symmetry invalidates the eigenfunction method as well as the diffusion map method. We show however that by building diffusion wavelets we can achieve the same efficiencies in computing diffusion distances, as well as Euclidean embedding as described in the symmetric case. For this reason, the use of the term “diffusion map”, and similar terms, in this disclosure should be taken as illustrative and not limiting, in the sense that the corresponding techniques with diffusion wavelets are more generally applicable. Anywhere where we have discussed applications of diffusion maps, etc, should be interpreted in this more general context.

The algorithms disclosed herein scale linearly in the number of samples—i.e. all pairs of documents are encoded and displayed in order N (or, for some aspects, N log N) where N is the number of samples, allowing for real-time updating. The documents can be displayed in Euclidean space so that the Euclidean distance measures the diffusion distance. The methods disclosed herein provide a natural data driven multiscale organization of data in which different time/scale parameters correspond to representations of the data at different levels of granularity, while preserving microscopic similarity relations.

The methods disclosed herein provide a means for steering the diffusion processes in order to filter or avoid irrelevant data as defined by some criterion. Such steering can be implemented interactively using the display of diffusion distances provided by the embedding. This can be implemented exactly as described in the section on hyper-interactive web site searching. This method includes but is not limited to the case of expert assisted machine learning of diagnosis or classification.

Additionally, an embodiment of such techniques to steer diffusion analysis consists of the following steps:

1. Apply the diffusion mapping algorithms in the context of a search or classification problem

2. Provide the initial results to a user

3. Allow the user to identify, by mouse click gestures or other means, examples of correct and incorrect results

4. For each class in the classification problem, or for the classes “correct” and “incorrect”:

4a. Use the diffusion process to propagate these user-defined labelings from the specific data elements selected in step 3 and corresponding to the current class, for a time t, so that the labels are spread over a substantial amount of the initial dataset

5. Collect the data vector of diffused class information (scores).

6. Use the data vector in step 5 as additional coordinates and goto step 1.

Alternatively

6_{—}1. Use the data vector in step 5 to change the initial metric from which the initial diffusion process was conducted. Do this as follows:

6_{—}1.1. Label each element in the initial dataset with a “guess classification” equal to the class for which its diffused class score is the highest.

6_{—}1.2 Modify the initial metric so that connections between data elements of the same guess class are enhanced, at least slightly, for at least some elements, and/or so that connections between data elements of different guess classes are reduced, at least slightly, for at least some elements

Alternatively, or in addition, steps 1 through 3 could be replaced by any means for allowing the user, or any other process or factor, including a priori knowledge, to label certain data elements in the initial dataset, with respect to class membership in a classification problem, or with respect to being “good” or “bad”, “hot” or “cold”, etc., with respect to some search or some desired outcome. The rest of the algorithm (steps 3-6 (or 3-6_{—}1.x) remain the same.

Alternatively, the above algorithm can be used in other aspects disclosed here, modified as one skilled in the art would see fit. For example, the technique can be used for regression instead of classification, by simply labeling selected components with numerical values instead of classification data. When the different values are propagated forward by diffusion, they could be combined by averaging, or in any standard mathematical way.

Other important properties and aspects of the present invention are:

Clustering in the diffusion metric leads to robust digital document segmentation and identification of data affinities;

Differing local criteria of relevance lead to distinct geometries, thus providing a mechanism for the user to filter away unrelated information;

Self organization of digital documents can achieved through local similarity modeling, in which the top eigenfunctions of the empirical model are used to provide global organization of the given set of data;

Situational awareness of the data environment is provided by the diffusion map embedding isometrically converting the (diffusion) relational inference metric to the corresponding visualized Euclidean distance;

Searches into the data and relevance ranking can be achieved via diffusion from a reference point;

Diffusion coordinates can easily be assigned to new data without having to recompute the map for new data streams.

The following description gives some further details of an embodiment of the present invention with respect to some aspects. It is meant to be illustrative and not limiting.

A system for computing the diffusion geometry of a corpus of documents consists of the following components (Part A): Data source(s); (optional) Data filter(s); initial coordinatization; (optional) nearest neighbor pre-processing and/or other sparsification of the next step; initial metric matrix calculation component (weighted so that the top eigenvalue is 1); (optional) decomposition of matrix into blocks corresponding to higher-multiplicity of eigenvalue 1; computation of top eigenvalues and eigenfunctions of the matrix from step 5; and projection of initial data onto said top coordinates.

Then, when one needs to compute the distance between two documents, one simply does this (part B): Choose a value of the time parameter t, by empirical, arbitrary, heuristic, analytical or algorithmic means; and the distance between document X and Y is then the sum of (lambda_i)̂t*(x_i−y_i)̂2, (where i denotes subscript i, lambda_i is eigenvalue number i from step 7 above (in descending order), * denotes multiplication, \hat{0} denotes exponentiation, x_i is the diffusion coordinates of X and y_i those of Y (ordered in the same order as the eigenvalues)

This system can be used in an application, for example as follows (part C): use Part A to gather and compute the diffusion geometry of a set of web pages; for each given page in the set of pages, use part B to find those pages in the set that are closest to the given page; optionally, pre-compute the top few closest pages to each page in the set; and provide a browser, plugin, proxy or content management, which, when rendering a web page, automatically inserts links to related pages, based on the metric information from part C, steps 2 and 3.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1-46. (canceled)

47. A method of representing data, comprising the steps of:
receiving a dataset comprising N digital documents; and
computing by a processor a diffusion geometry of said dataset comprising at least a plurality of diffusion coordinates, said coordinates being scaled by diffusion time and admitting an extension to any additional new digital document, wherein the time scale represents the length of inference paths between documents; and
storing first k diffusion coordinates for each digital document in the dataset comprising N digital documents in a memory, wherein k depends on a selected time scale and selected precision; and
adding new digital documents to original dataset by calculating and storing said extension of said first k diffusion coordinates by said processor.

48. The method of claim 47, further comprising the step of calculating and optionally storing in said memory an approximation of a diffusion distance between all pairs of digital documents in said dataset by said processor, said approximation being calculated by applying the Euclidean metric to k stored diffusion coordinates of said all pairs of digital documents, and wherein precision of said approximation is related to the chosen time scale and a value of said k.

49. The method of claim 48, further comprising the step of displaying said dataset based on at least one diffusion coordinate on a display device.

50. The method of claim 48, further comprising the step of displaying said dataset based on at least two diffusion coordinates on a display device.

51. The method of claim 48, further comprising the steps of detecting outliers and anomalies in said original dataset of N digital documents or any new digital documents subsequently added to said original dataset by measuring said diffusion distance from each digital document to a nearest digital document and comparing said diffusion distance to a predetermined threshold value by said processor.

52. The method of claim 47, wherein said dataset is a symmetric or non-symmetric directed graph comprising N nodes, and further comprising the step of computing a diffusion geometry of said directed graph comprising at least a plurality of diffusion coordinates derived from diffusion wavelets at different time scales by said processor.

53. The method of claim 52, further comprising the step of organizing said plurality of diffusion coordinates in a hierarchical manner at different levels of granularity or time scale by said processor.

54. The method of claim 47, further comprising the step of computing diffusion wavelets from said diffusion geometry by said processor.

55. The method of claim 54, further comprising the step of building a multi-scale structure on said N documents in accordance with said computed diffusion wavelets by said processor.

56. The method of claim 54, further comprising the step of encoding functions on graphs or manifolds approximated with said diffusion wavelets by said processor.

57. The method of claim 47, further comprising the step of compressing and extending functions on graphs or manifolds by approximating the functions as a linear combination of a subset of said diffusion coordinate functions that are extendable off the original dataset by said processor.

58. A computer system configured to represent a dataset comprising N digital documents, comprising:
a processor for computing a diffusion geometry of said dataset comprising at least a plurality of diffusion coordinates, said coordinates being scaled by diffusion time and admitting an extension to any additional new digital document, wherein a time scale represents a length of inference paths between documents; and
a memory for storing first k diffusion coordinates for each digital document in said dataset comprising N digital documents, wherein k depends on selected time scale and selected precision; and
wherein said processor is operable to add new digital documents to said original dataset by calculating and storing extension of said first k diffusion coordinates.

59. The computer system of claim 58, wherein said processor is operable to calculate and optionally store an approximation of the diffusion distance between all pairs of digital documents in said dataset in said memory, said approximation being calculated by applying the Euclidean metric to said k stored diffusion coordinates of said pairs of digital documents, and where the precision of said approximation is related to the chosen time scale and a value of said k.

60. The computer system of claim 59, further comprising a display device for displaying said dataset based on at least one diffusion coordinate.

61. The computer system of claim 59, further comprising a display device for displaying said dataset based on at least two diffusion coordinates.

62. The computer system of claim 59, wherein said processor is further operable to detect outliers and anomalies in said original dataset of N digital documents or any new digital documents subsequently added to the dataset for each digital document in the dataset by measuring the diffusion distance to said each digital document's nearest neighbor and comparing said distance to a predetermined threshold value.

63. The computer system of claim 58, wherein said dataset is a symmetric or non-symmetric directed graph comprising N nodes, and wherein said processor is operable to compute a diffusion geometry of said directed graph comprising at least a plurality of diffusion coordinates derived from diffusion wavelets at different time scales.

64. The computer system of claim 58, wherein said processor is operable to compute diffusion wavelets from said diffusion geometry.

65. The computer system of claim 64, wherein said processor is operable to build a multi-scale structure on said N documents in accordance with said diffusion wavelets.

66. The computer system of claim 69, wherein said processor is operable to compress and extend functions on graphs or manifolds by approximating said function as a linear combination of a subset of said diffusion coordinate functions that are extendable off the original dataset.
